(19) United States
(12) Patent Application Publication
(10) Pub. No.: US 2025/0345981 A1
(43) Pub. Date: Nov. 13, 2025

(54) PROCESS, ARTICLE AND ASSEMBLY FOR INTEGRATING A BARCODE IN A THERMO-FORMABLE MATERIAL

(71) Applicant: U.S. Farathane, L.L.C., Auburn Hills, MI (US)

(72) Inventors: Donald Cvengros, Canton, MI (US); Michael Caringi, Grosse Pointe Woods, MI (US); Robert Huey, Holland, OH (US)

(21) Appl. No.: 18/929,021

(22) Filed: Oct. 28, 2024

Related U.S. Application Data
(60) Provisional application No. 63/644,155, filed on May 8, 2024.

(51) Int. Cl. B29C 51/30; B29C 51/00; B29C 51/08; B29K 67/00; B29K 105/00

(52) U.S. Cl. CPC B29C 51/30; B29C 51/004; B29C 51/082; B29K 2067/003; B29K 2105/256

(57) ABSTRACT

A process, article and assembly for forming a barcode into a thermo-formed part which is readable from either of first and second sides thereof. A non-woven material is heated in an oven prior to being advanced to a die press having first and second opposing surfaces. Additional steps include providing a die plate incorporating an embossed arrangement of the barcode into either of the first or second opposing die surfaces and compressing the heated material between the die surfaces in order to form a reverse embossment pattern of the barcode into each of opposite first and second surfaces of the material, such that a scanner device is capable of reading the barcode from either of the surfaces.

### CROSS REFERENCE TO RELATED APPLICATIONS

The present application claims priority of U.S. Ser. No. 63/644,155 filed May 8, 2024.

### FIELD OF THE INVENTION

The present invention relates generally to the formation of a barcode into a part. More specifically, the present invention teaches a process and assembly for die forming a barcode, which can additionally include any of a data matrix or QR code into a thermo-formable material, such as which typically includes a non-woven material such as a polyethylene terephthalate or like thermoplastic polymer resin, as well as including a glass reinforced thermoplastic or other polypropylene based material. The 1D or 2D code is formed by embossment due to the melting of the raw material when forming/compression molding the part. The character and nature of the code permits it to be read by a suitable scanning device from either of opposite A (finished) or B (unfinished) sides.

### BACKGROUND OF THE INVENTION

Current compression molded parts either include no integrated scan-able part recognition aspects or which adhesively attaches a paper or poly label. In the latter instance, the incidence of labels becoming separated from the parts results in the parts becoming mixed and often misidentified when placed in the associated bins for shipment to the assembly facility.

An example of a nonwoven material encoding an optical readable code is set forth in U.S. Pat. No. 11,544,488 to Polosa, which teaches a pattern displaying at least two groups of areas having different optical properties distinguishable to reading and decoding equipment. The pattern may arise from differences in the microstructure of the web. The nonwoven material may have an embossed pattern having a basic, static component and a dynamic component which varies within a given length of the nonwoven web. Also disclosed is a method for obtaining information from a nonwoven web, comprising observing the web surface using an optical reading device, collecting data based on differences in optical properties in the web surface, storing in a digital memory a pattern based on the collected data and comparing the stored pattern to a collection of previously stored patterns.

### SUMMARY OF THE INVENTION

The present invention teaches a process for die forming a barcode, such including without limitation any of a data matrix or QR code, which is heat formed via compression into a thermo-formable or nonwoven material, further such as a polyethylene terephthalate, a like thermoplastic polymer resin, as well as potentially any of a glass reinforced thermoplastic or other polypropylene based material. The 1D or 2D code is formed by embossment due to the melting of the raw material when forming/compression molding the part. The character and nature of the code permits it to be read by a suitable scanning device from either of opposite A (finished) or B (unfinished) sides.

A corresponding assembly for forming a barcode within a thermo-formable material includes a first conveyor advancing the material into an oven for heating the material. A second conveyor removes the heated material from the oven and advancing in position over a lower die forming tool. An upper die forming tool displaces the heated material into contact with the lower die forming tool to form a part from the material. A branding plate is incorporated into either of the upper or lower die forming tools for forming a reverse embossment pattern of a barcode integrated into the plate upon each of opposite first and second surfaces of the material.

A thermo-formable material incorporating a barcode is also disclosed and teaches a non-woven material, with a reverse embossment pattern of a barcode associated with the die forming operation being formed into each of opposite first and second surfaces of the material. The non-woven material further includes any of a polyethylene terephthalate or thermoplastic polymer resin, as well as any of a glass reinforced thermoplastic, natural fiber or other polypropylene based material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a mold assembly depicting a non-woven material prior to entering an oven;

FIG. 2 depicts the material within the oven and depicting its heating elements;

FIG. 3 is depicts the heated material exiting the oven;

FIG. 4 successively depicts the material entering the die press;

FIG. 5 successively depicts the material draped over the forming tool of the press;

FIG. 6 depicts the tool being closed in order to form the part, with the associated insertable die for emboss forming the readable 2D code;

FIG. 7 depicts the compress formed part with the integrated barcode readable from either of the first and second sides of the part;

FIG. 8 depicts the opened tool for receiving the next heated part to be formed;

FIGS. 9A-9D illustrate a non-limiting variety of branding plate embossments configured upon the insertable die and including each of a barcode (FIG. 9A) and a variety of data matrix or like optical recognition codes (FIGS. 9B-9D);

FIG. 10 provides an illustration of an embossing branding plate positioned within the die forming tool according to the present invention;

FIGS. 11A-11D illustrate examples of an embossed barcode formed in the non-woven part and include, in non-limiting fashion, each of a QR code formed in an A side of the part, a reverse B side of the part depicting the QR code which is also scan-able from the reverse side, a data matrix code formed on an A side of the part, and a reverse B side of the part depicting the data matrix code likewise readable/scan-able from the reverse side;

FIGS. 12 depicts a further example of a tool design placement scheme for incorporating the branding plate into such as a vehicle wheel liner die surface;

FIGS. 12A and 12B depict corresponding die inserts placed within a mirrored arrangement of the wheel liner die surfaces shown in FIG. 12;

FIG. 13 is an illustration of a tool die insert similar to as shown in FIGS. 12A-12B, with successive FIG. 13A depicting a non-limiting example of a data matrix code incorporated into the insert for forming the desired embossment into the non-woven part, and which provides the design contrast between the raised and shiny surfaces in order to provide better contrast to permit scanning from either of the A or B sides of the part;

FIG. 14 provides a chart depicting a large bar code sample of 40 mm×40 mm optical character recognition or data matrix code, with FIG. 14A further depicting embossment depths at each of a dozen point mapping locations of an embossed barcode for each of four part liner samples; and

FIG. 15 provides a chart depicting a smaller bar code sample of 30 mm×30 mm optical character recognition or data matrix code, with FIG. 15A further depicting embossment depths at each of a dozen point mapping locations of an embossed barcode for each of four part liner samples.

### DETAILED DESCRIPTION OF THE PREFERRED EMBODIMENTS

With reference to the attached illustrations, the present invention discloses a process and assembly for die forming a barcode, including any of a data matrix or QR code into a thermo-formable material, such as typically including a non-woven material including a polyethylene terephthalate or like thermoplastic polymer resin. As will be further described, the 1D or 2D code is formed by embossment due to the melting of the raw material (such as without limitation a polyethylene terephthalate or like thermoplastic polymer resin) when forming/compression molding the part. The character and nature of the code permits it to be read by a suitable scanning device from either of opposite A (finished) or B (unfinished) sides.

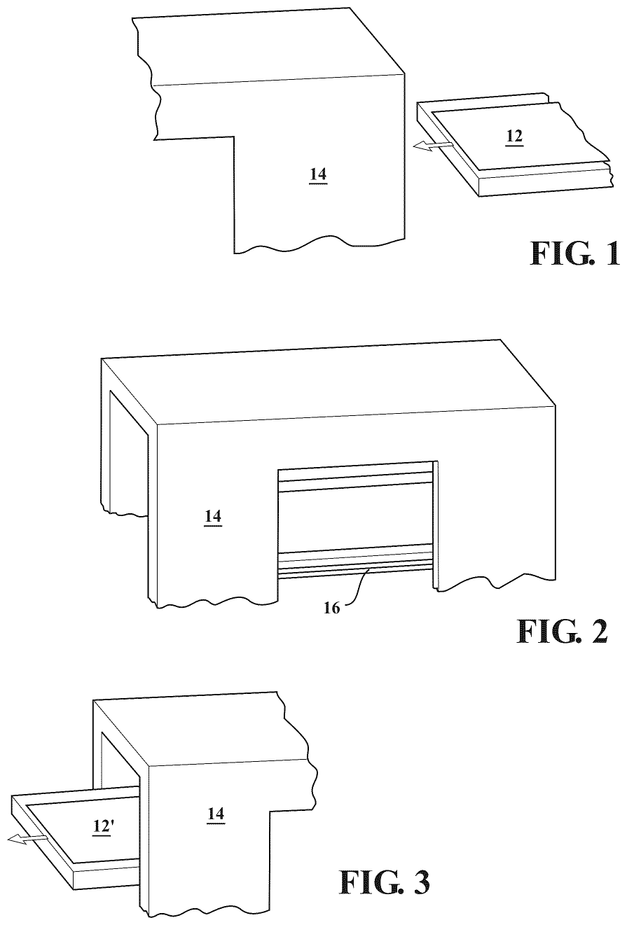

Referring to FIG. 1, presented is an illustration, generally at 10, of a mold assembly depicting a non-woven material 12 prior to entering an oven 14. FIG. 2 depicts the material within the oven 14 and depicting its heating elements 16.

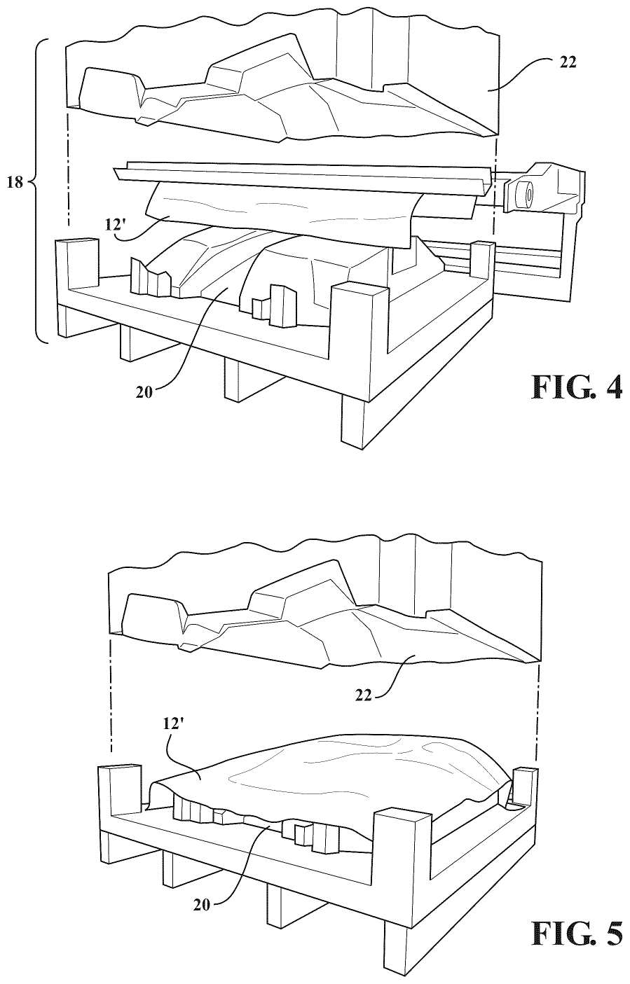

FIG. 3 depicts the heated material at 12′, exiting the oven, with FIG. 4 successively depicting the material entering a die press 18. FIG. 5 successively depicts the heated thermo-formable or non-woven material 12′ draped over a first lower half 20 of a forming tool of the press (also depicting a second overhead positioned upper die or forming tool half 22).

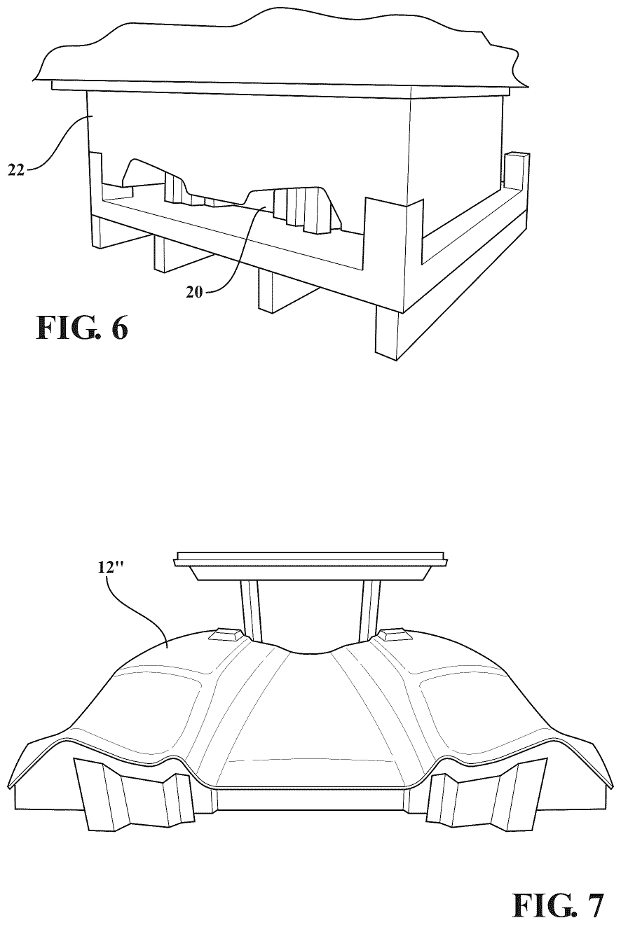

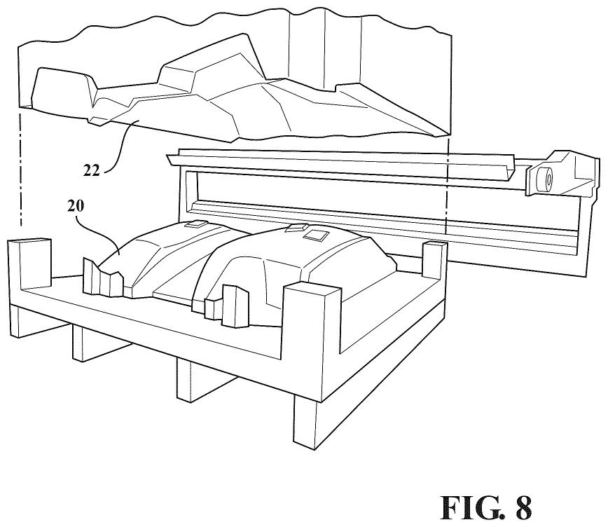

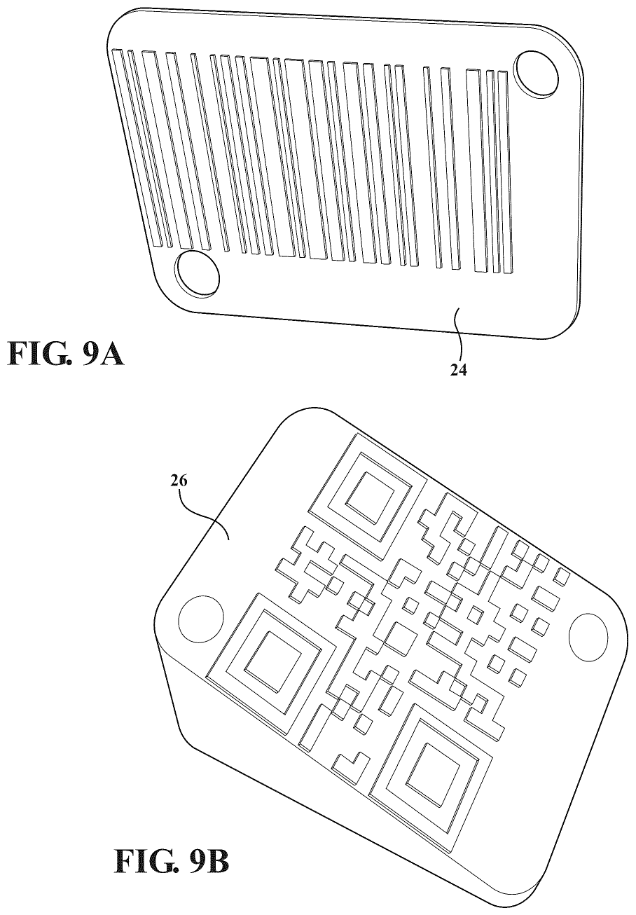

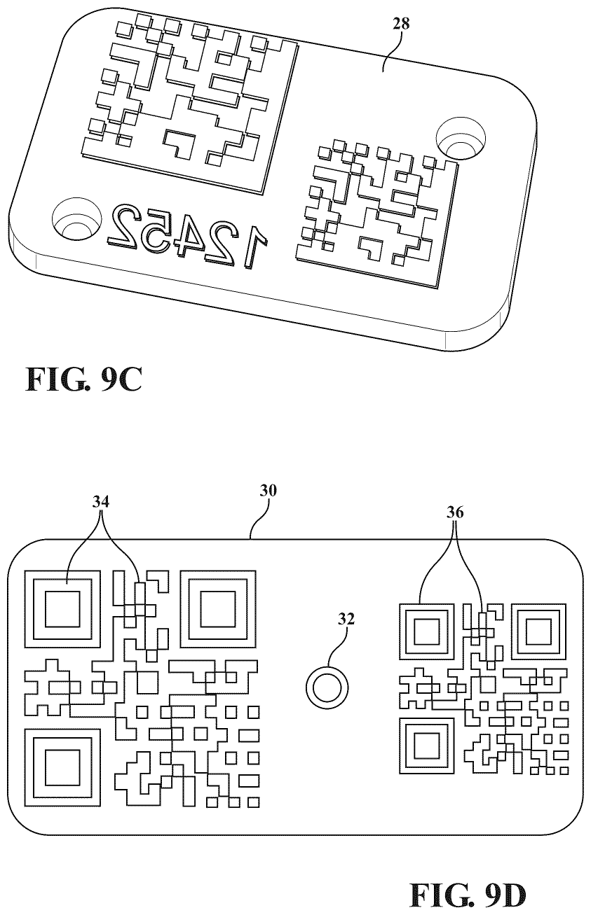

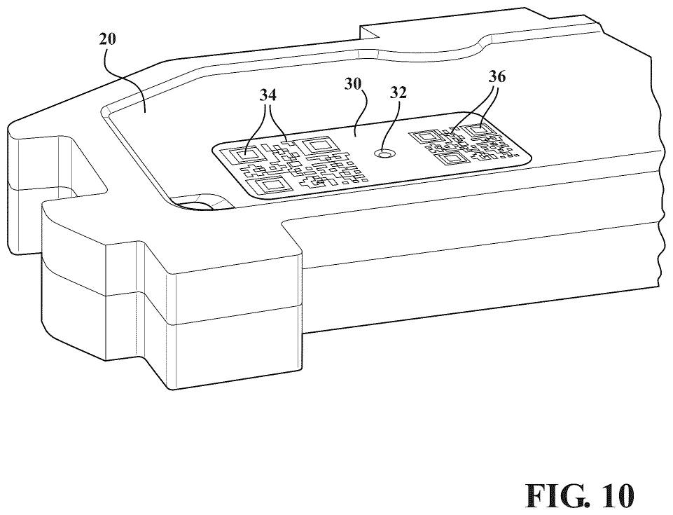

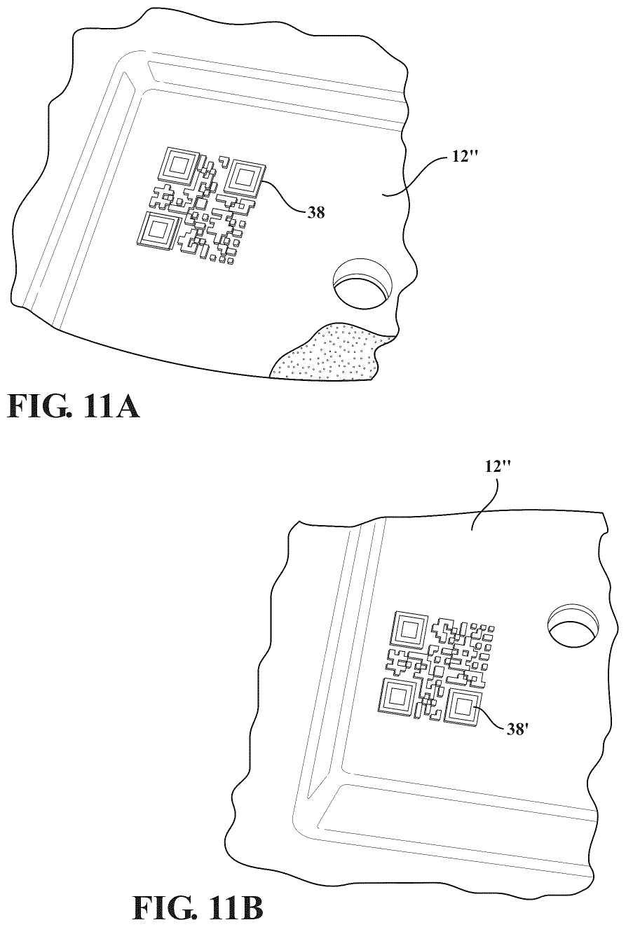

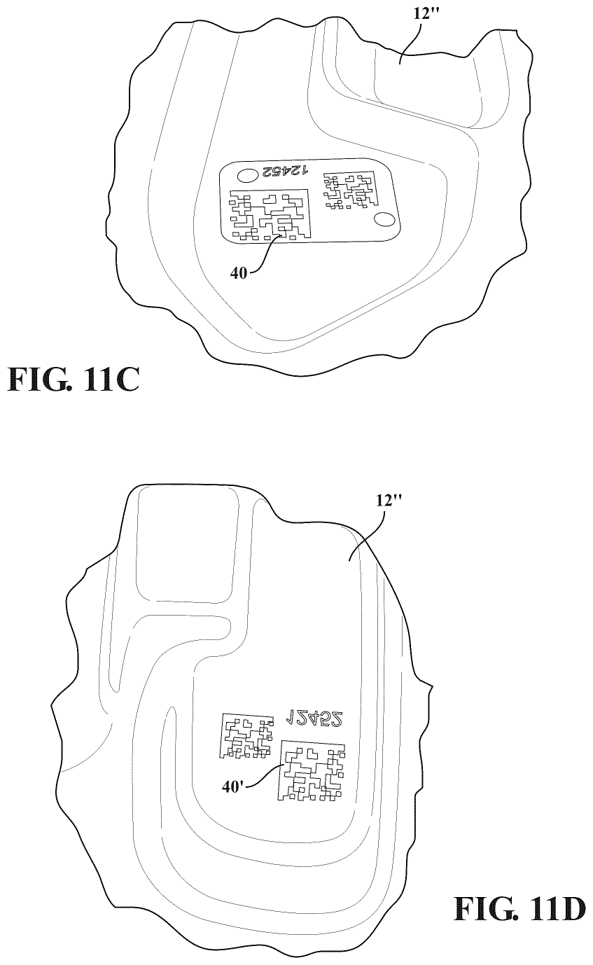

FIG. 6 depicts the tool (again defined by lower 20 and upper 22 die halves) being closed in order to form the part, with the associated insertable branding plate (referenced in FIGS. 9A-9D) emboss forming the readable 2D code into a selected one of the die surfaces opposing the part (further reference being had to FIG. 10). FIG. 7 depicts the compress formed part, now at 12″, with the integrated code readable from either of the first and second sides (reference being had to FIGS. 11A-11D) of the formed part. FIG. 8 subsequently depicts the opened tool for receiving the next heated part to be formed.

FIGS. 9A-9D illustrate a non-limiting variety of branding plate embossments configured upon the insertable die and including each of a barcode 24 (FIG. 9A) and a variety of data matrix or like optical recognition codes which include at 26 in FIG. B, at 28 in FIG. 9C, and at 30 in FIG. 9D. As depicted in each example, the die plates 24, 26, 28 and 30 each depict an offset embossed arrangement which, upon compressed thermoforming the part in the mold, results in a negative impression being formed into each of the primary or decorative A side as well as the reverse or B side (see again FIGS. 11A-11D).

By definition, barcode recognition efficiently captures index data and includes two different types 1D and 2D. Traditional barcodes (1D as represented at 24) represent each character by a vertical line, such as which are arranged horizontally. These linear barcodes become impractical when the number of characters exceeds thirty. Newer 2D barcodes (see again as reflected in FIG. 9D) represent characters by small cells, which are arranged both vertically and horizontally and can accommodate several times the number of characters that a linear barcode can.

FIG. 10 provides an illustration of a selected embossing branding plate, again at 30, positioned within the lower half 20 of the die forming tool according to the present invention formed corresponding to the locations of the embossed melted surface of the pair of liners). The branding plates can be interchangeable (such as through the use of conventional screws or other fasteners) and are dimensioned so as to be installed within a mating surface depression in the selected die half, such as including a mounting screw and aligning threaded apertures (at 32). As further shown, the embossment patterns of the data/optical character recognition features are depicted at 34 and 36.

FIGS. 11A-11D illustrate examples of an embossed barcode formed in the non-woven part formed part (consistently represented again at 12″) and include, in non-limiting fashion, each of a QR code 38 formed in an A side of the part (FIG. 11A), a reverse B side of the part (FIG. 11B) depicting the QR code 38′ which is also scannable from the reverse side. Also shown is a data matrix code 40 formed on an A side of the part (FIG. 11C), along with a reverse B side of the part depicting the data matrix code 40′ likewise readable/scan-able from the reverse side of the part (FIG. 11D).

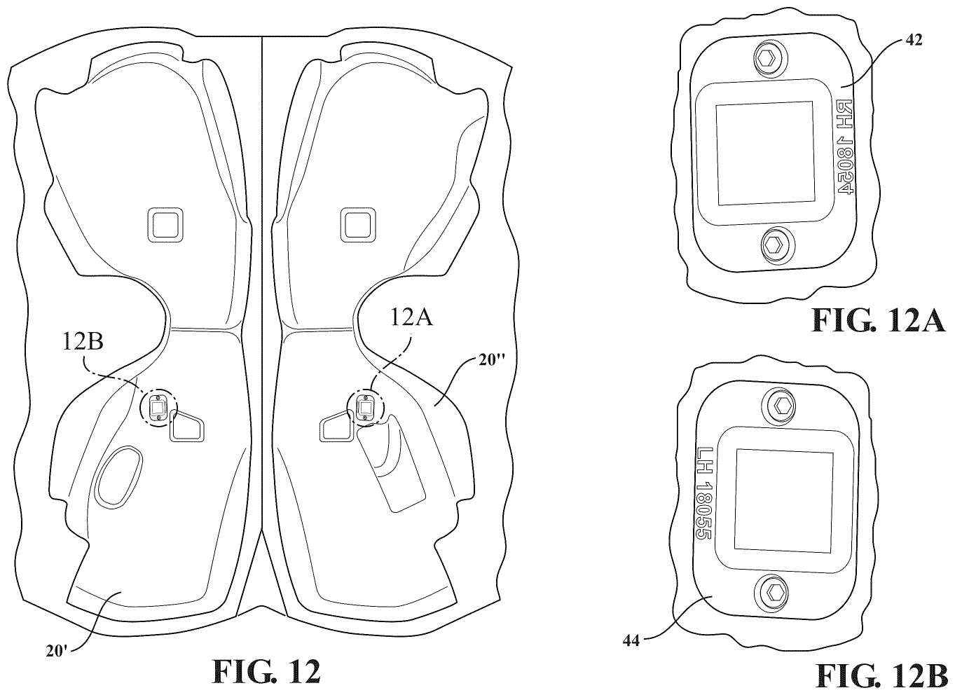

FIG. 12 depicts a further example of a tool design placement scheme (depicted as lower die half subsections 20′ and 20″), for incorporating the branding plate into such as a vehicle wheel liner die surface. Figures. 12A and 12B depict corresponding die inserts, shown at 42 and 44 respectively placed within an arrangement of the wheel liner die surfaces shown in FIG. 12 (which can be but is not necessarily in a mirrored arrangement), corresponding to each of right handed and left handed sides of a pair of wheel liner parts.

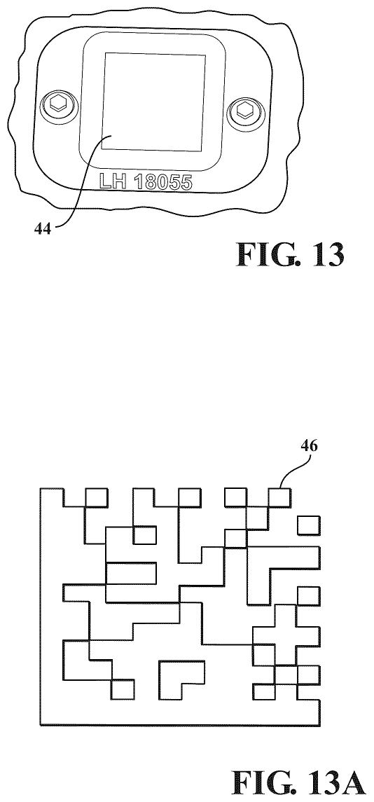

FIG. 13 is an illustration of a tool die insert or branding plate, again at 44, similar to as shown in FIGS. 12A-12B, with successive FIG. 13A depicting a non-limiting example of a data matrix code 46 incorporated into the insert for forming the desired embossment into the typically non-woven part, and which provides the design contrast between the raised and shiny surfaces in order to provide better contrast to permit scanning from either of the A or B sides of the part.

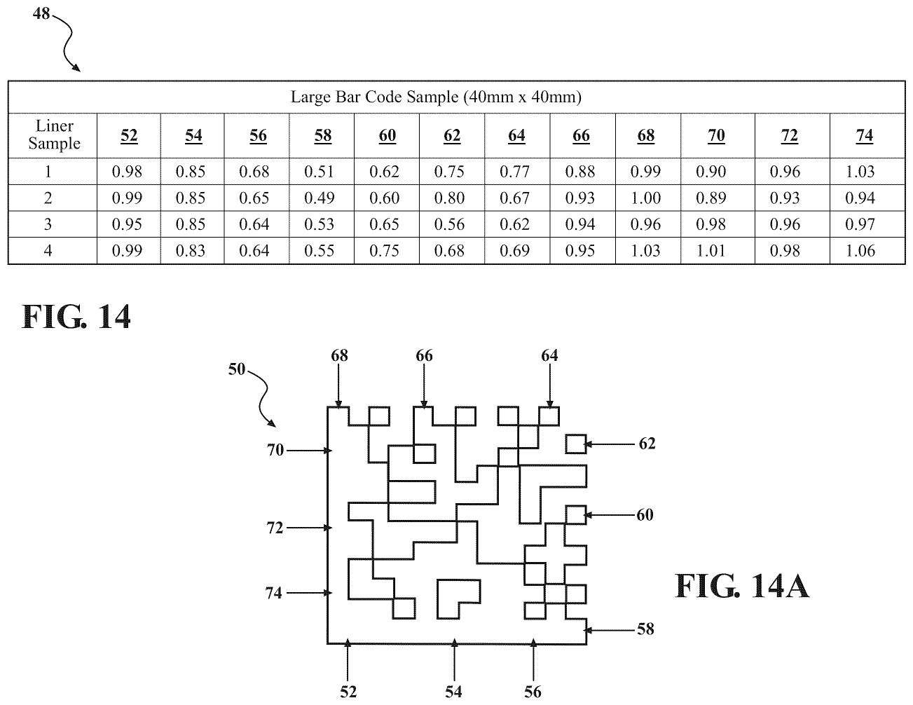

FIG. 14 provides a chart, at 48, depicting a large bar code sample of 40 mm×40 mm optical character recognition or data matrix code, with FIG. 14A further depicting embossment depths (in mm) of an embossed barcode 50 at each of a dozen point mapping locations shown at each of 52, 54, 56, 58, 60, 62, 64, 66, 68, 70, 72 and 74 for each of four part liner samples.

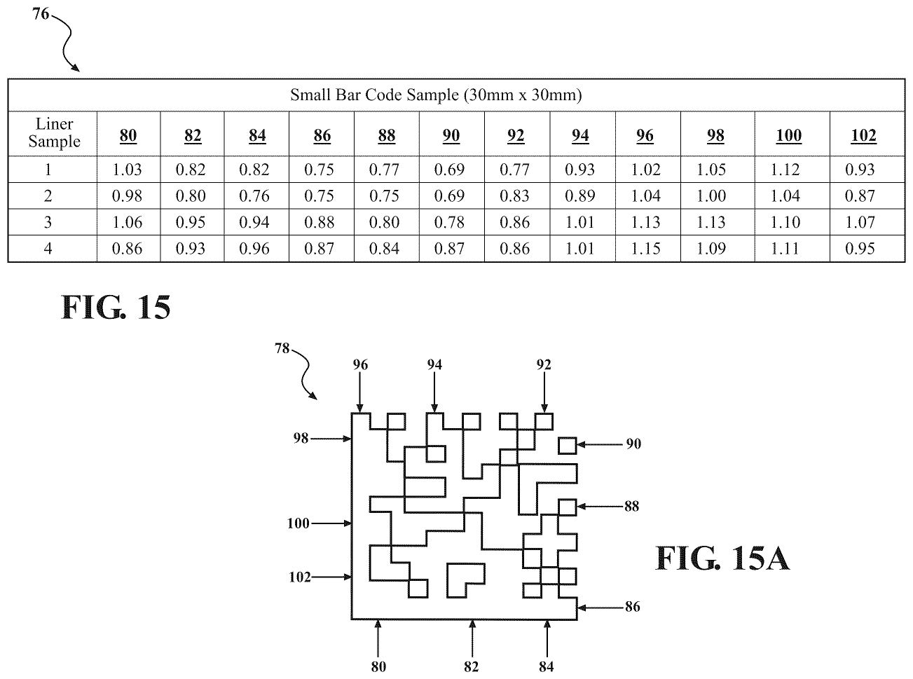

Finally, FIG. 15 provides a chart 76 depicting a smaller bar code sample of 30 mm×30 mm optical character recognition or data matrix code, with FIG. 15A further depicting embossment depths at an embossed code 78 each of a dozen point mapping locations 80, 82, 84, 86, 88, 90, 92, 94, 96, 98, 100 and 102 for each of four part liner samples.

Without limitation, the material selection for die forming the part can include those additional to a non-woven material such as a PET. This can further typically include any suitable polymer formable material exhibiting a grams per square meter (GSM) range of 1000-1400. Without limitation, the material selection can further include any type of glass reinforced thermoplastic (LWRT), natural fiber or other polypropylene based material.

A corresponding process for die forming a barcode into a formed part is also disclosed and includes the steps of providing a thermo-formable material, heating the material in an oven, advancing the heated material to a die press having first and second opposing surfaces and providing a die plate incorporating an embossed arrangement of the barcode into any of the first or second opposing die surfaces. Additional steps include compressing the heated material between the die surfaces in order to form a reverse embossment pattern of the barcode into each of opposite first and second surfaces of the material and utilizing a scanner device capable of reading the code from either of the first and second surfaces.

Other steps include the embossed arrangement of the barcode further forming any of a QR code or a matrix data code. The step of providing the thermo-formable material further includes providing a non-woven material, which can further be any of a polyethylene terephthalate or thermoplastic polymer resin. The said step of providing the thermo-formable material further can include providing any of a glass reinforced thermoplastic, natural fiber or other polypropylene based material.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A process for die forming a barcode into a formed part, comprising the steps of:
providing a thermo-formable material;
heating the material in an oven;
advancing the heated material to a die press having first and second opposing surfaces;
providing a die plate incorporating an embossed arrangement of the barcode into any of the first or second opposing die surfaces;
compressing the heated material between the die surfaces in order to form a reverse embossment pattern of the barcode into each of opposite first and second surfaces of the material; and
utilizing a scanner device capable of reading the code from either of the first and second surfaces.

2. The process according to claim 1, said step of incorporating an embossed arrangement of the barcode further comprising forming any of a QR code or a matrix data code.

3. The process according to claim 1, said step of providing the thermo-formable material further comprising providing a non-woven material.

4. The process according to claim 3, said step of providing a non-woven material further comprising providing any of a polyethylene terephthalate or thermoplastic polymer resin.

5. The process according to claim 1, said step of providing the thermo-formable material further comprising providing any of a glass reinforced thermoplastic, natural fiber or other polypropylene based material.

6. An assembly for forming a barcode within a thermo-formable material, comprising:
a first conveyor advancing the material into an oven for heating the material;
a second conveyor removing the heated material from the oven and advancing in position over a lower die forming tool;
an upper die forming tool displaced into contact with the lower die forming tool to form a part from the material; and
a plate incorporated into either of the upper or lower die forming tools for forming a reverse embossment pattern of a barcode integrated into the plate upon each of opposite first and second surfaces of the material.

7. The assembly according to claim 6, the barcode further comprising any of a QR code or a matrix data code.

8. A thermo-formable material incorporating a barcode, comprising:
a non-woven material; and
a reverse embossment pattern of a barcode associated with a die forming operation being formed into each of opposite first and second surfaces of the material.

9. The material of claim 8 the non-woven material further comprising any of a polyethylene terephthalate or thermoplastic polymer resin.

10. The material of claim 8, further comprising any of a glass reinforced thermoplastic. natural fiber or other polypropylene based material.
